(19) United States
(12) Patent Application Publication
(10) Pub. No.: US 2009/0271638 A1
(43) Pub. Date: Oct. 29, 2009

(54) Storage system with an encryption function

(75) Inventors: Norihiko Kawakami, Hachioji (JP); Akira Nishimoto, Sagamihara (JP); Junji Ogawa, Sagamihara (JP)

Correspondence Address: Juan Carlos A. Marquez;c/o Stites & Harbison PLLC, 1199 North Fairfax Street, Suite 900, Alexandria, VA, 22314-1437, US

(73) Assignee: Hitachi, Ltd.

(21) Appl. No.: 12/007,876

(22) Filed: Jan. 16, 2008

(30) Foreign Application Priority Data
Sep. 7, 2007 (JP) 2007-232841

(51) Int. Cl. G06F 12/14; H04L 9/00

(52) U.S. Cl. 713/193; 380/277; 711/112; 711/E12.092

(57) ABSTRACT

To reduce the performance degradation of storage system, this invention provides a storage system comprising a disk drive and a disk controller. The disk controller provides a storage area of the disk drive to a host computer; executes a processing of switching an encryption key that is used to encrypt data stored in the logical volume from a first encryption key to a second encryption key; encrypts write data requested to be written with the second encryption key when the write request for one of storage areas within the logical volume that stores data for which switching of encryption keys has not been finished is received while the encryption key switching processing is being executed; and writes the encrypted write data in the logical volume to switch encryption keys for data stored in the storage area where the data is requested to be written by the received write request.

### CLAIM OF PRIORITY

The present application claims priority from Japanese patent application JP 2007-232841 filed on Sep. 7, 2007, the content of which is hereby incorporated by reference into this application.

### BACKGROUND

This invention relates to a storage system. In particular, this invention relates to a storage system with an encryption function.

The importance of data stored in storage systems has been increasing in recent years, and storage systems are desired to have an encryption function. To have an encryption function, a storage system must be equipped with a function of converting plaintext into ciphertext and a function called a rekey function with which an encryption key is changed to another encryption key.

Conventional storage systems cannot accept I/O from a host computer during a processing of converting plaintext into ciphertext and during a rekey processing, which lowers the performance of the storage systems.

JP 2005-303981 A discloses a technique of avoiding a drop in storage system performance during the rekey processing. The technique disclosed in JP 2005-303981 A allows a storage system to perform the rekey processing while accepting I/O from a host computer.

With the technique disclosed in JP 2005-303981 A, a storage system manages on a block basis a logical volume (LU) on which the rekey processing is performed. The storage system uses a pointer in managing up to which block the rekey processing has been finished.

When a request to write data in an LU on which the rekey processing is performed is received from a host computer during the rekey processing, the storage system judges from the pointer whether or not a block where the data is requested to be written has been performed rekey processing.

In the case where the block has been rekeyed, the storage system encrypts the write data with an encryption key assigned through performing rekey processing, and writes the encrypted data in this block. In the case where the block has not been performed rekey processing, on the other hand, the storage system encrypts the write data with an encryption key assigned before performing rekey processing, and writes the encrypted data in this block.

According to the technique of JP 2005-303981 A, a storage system thus encrypts write data with an encryption key that is assigned to a block where the write data is to be written.

### SUMMARY

A problem of the technique disclosed in JP 2005-303981 A is that data written in a block during the rekey processing of the block is also performed rekey processing. In other words, a storage system has to decrypt and re-encrypt data that is written in a block during the rekey processing of the block, which lowers the performance of the storage system.

This invention has been made in view of the problems described above, and it is therefore an object of this invention to provide a technique of reducing the performance degradation of storage system during a processing of converting plain text into cipher text and during the rekey processing.

A representative aspect of this invention is as follows. That is, there is provided a storage system connected to a host computer, comprising: a disk drive which stores data requested by the host computer to be written; and a disk controller which controls data read and data write to the disk drive. The disk controller provides a storage area of the disk drive to the host computer as at least one logical volume; executes a processing of switching an encryption key that is used to encrypt data stored in the logical volume from a first encryption key to a second encryption key; encrypts write data which is requested to be written by a received write request with the second encryption key when the write request for one of storage areas within the logical volume that stores data for which switching of encryption keys has not been finished is received while the encryption key switching processing is being executed; and writes the encrypted write data in the logical volume to switch encryption keys for data stored in the storage area where the data is requested to be written by the received write request.

According to the representative mode of this invention, the performance degradation of storage system during a processing of converting plain text into cipher text and during the rekey processing can be reduced.

### BRIEF DESCRIPTION OF THE DRAWINGS

The present invention can be appreciated by the description which follows in conjunction with the following figures, wherein:

FIG. 1 is a block diagram showing the configuration of a computer system in accordance with an embodiment of this invention;

FIG. 2 is an explanatory diagram outlining a rekey processing executed in the computer system in accordance with the embodiment of this invention;

FIG. 3 is a configuration diagram showing an encryption key management table stored in a controller in accordance with the embodiment of this invention;

FIG. 4 is a configuration diagram showing an encrypted area management table stored in the controller in accordance with the embodiment of this invention;

FIG. 5 is a configuration diagram showing an encryption state management table stored in the controller in accordance with the embodiment of this invention;

FIG. 6 is a flow chart of the rekey processing executed by the computer system in accordance with the embodiment of this invention;

FIG. 7 is an explanatory diagram showing the rekey configuration screen which is displayed on a management computer in accordance with the embodiment of this invention;

FIG. 8 is a flow chart of a host I/O processing that is executed during a rekey processing by the storage system in accordance with the embodiment of this invention;

FIG. 9 is a flow chart of a write processing that is executed during a rekey processing by the storage system in accordance with the embodiment of this invention;

FIG. 10 is a flow chart of a write and parity generating processing executed by the storage system in accordance with the embodiment of this invention;

FIG. 11 is a flow chart of a processing at the time of failure occurrence of the storage system in accordance with the embodiment of this invention;

FIG. 12 is a flow chart of a processing at the time of failure recovery of the storage system in accordance with the embodiment of this invention; and

FIG. 13 is an explanatory diagram outlining an encryption processing executed by the computer system in accordance with the embodiment of this invention.

### DETAILED DESCRIPTION OF THE PREFERRED EMBODIMENT

An embodiment of this invention will be described below with reference to the accompanying drawings.

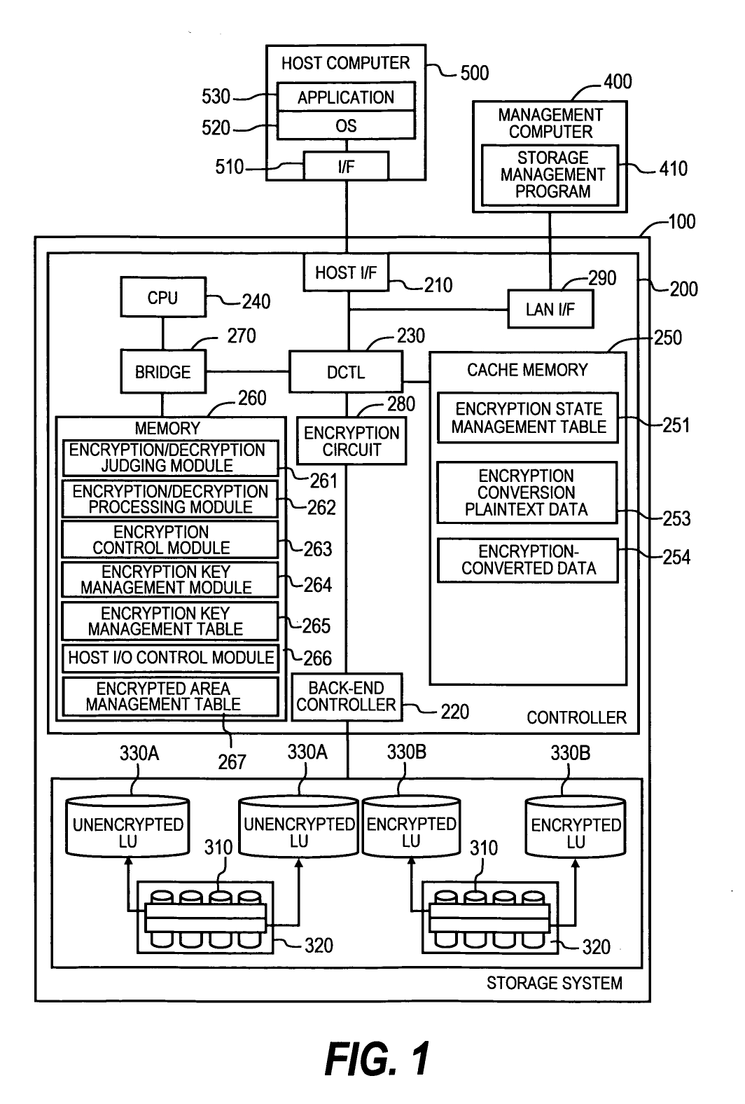

FIG. 1 is a block diagram showing the architecture of a computer system according to the embodiment of this invention.

The computer system has a host computer 500, a management computer 400, and a storage system 100.

The host computer 500 and the storage system 100 are connected to each other via a network such as a SAN. The management computer 400 and the storage system 100 are connected to each other via a management network which is a LAN or the like.

The host computer 500 is a computer that issues I/O to the storage system 100. The I/O is a write request, a read request, or the like.

The host computer 500 has a CPU (omitted from the drawing), a memory (omitted from the drawing), and an interface (I/F) 510. The interface 510 is connected to the storage system 100 via the network.

The CPU executes a program stored in the memory to perform various types of processings. The memory stores a program executed by the CPU, information needed by the CPU, and the like. For example, the memory stores an Operating System (OS) 520 and an application program 530.

The OS 520 controls the overall processings of the host computer 500. The application program 530 executes processings related to various business operations. In executing the processing, the application program 530 issues I/O to the storage system 100.

The management computer 400 is a computer that controls processing of the storage system 100. The management computer 400 has a CPU (omitted from the drawing), a memory (omitted from the drawing), and an interface (omitted from the drawing). The interface is connected to the storage system 100 via the management network.

The CPU executes a program stored in the memory to perform various types of processings. The memory stores a program executed by the CPU, information needed by the CPU, and the like. For example, the memory stores a storage management program 410.

The storage management program 410 controls processings of the storage system 100. For example, the storage management program 410 sends various requests to the storage system 100.

The storage system 100 has a controller 200 and multiple disk drives 310. The controller 200 reads and writes data in the disk drives 310. The controller 200 sets multiple disk drives 310 as a RAID group 320. The controller 200 provides the storage area of each RAID group 320 as at least one logical volumes (LUs) 300 to the host computer 500. The LUs 330 include unencrypted LUs 330A and encrypted LUs 330B.

The unencrypted LUs 330A are LUs that store unencrypted data (plaintext data). The encrypted LUs 330B are LUs that store encrypted data (ciphertext data).

The controller 200 has a host interface (host I/F) 210, a back-end controller 220, a data link control circuit (abbreviated as “DCTL” in the drawings) 230, a processor (abbreviated as “CPU” in the drawings) 240, a cache memory 250, a memory 260, a bridge 270, an encryption circuit 280, and a LAN interface (LAN I/F) 290.

The host interface 210 is connected to the host computer 500 via the network. The LAN interface 290 is connected to the management computer 400 via the management network. The back-end controller 220 is connected to the disk drives 310.

The bridge 270 controls data transfer among the DCTL 230, the CPU 240, and the memory 260. The DCTL 230 controls data transfer among the host interface 210, the cache memory 250, the bridge 270, the encryption circuit 280, and the LAN interface 290.

The encryption circuit 280 refers to a judgment made by an encryption/decryption judging module 261, and encrypts or decrypts data accordingly.

The memory 260 stores a program executed by the CPU 240, information needed by the CPU 240, and the like. Specifically, the memory 260 stores an encryption key management table 265 and an encrypted area management table 267. The encryption key management table 265 and the encrypted area management table 267 may be stored in the cache memory 250 instead of the memory 260.

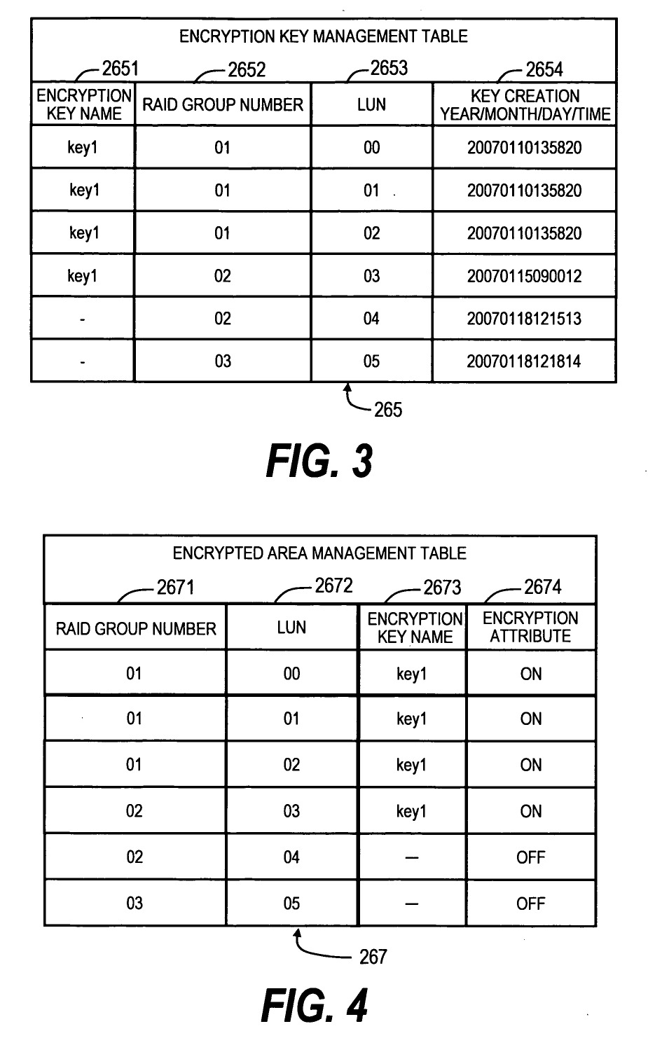

The encryption key management table 265 is used to manage information about an encryption key. Details of the encryption key management table 265 will be described with reference to FIG. 3.

The encrypted area management table 267 shows the relation between a storage area and an encryption key that is used to encrypt data stored in the storage area. Details of the encrypted area management table 267 will be described with reference to FIG. 4.

The CPU 240 executes a program stored in the memory 260 to perform various types of processings. Specifically, the CPU 240 executes a program stored in the memory 260 to implement the encryption/decryption judging module 261, an encryption/decryption processing module 262, an encryption control module 263, an encryption key management module 264, and a host I/O control module 266.

The encryption/decryption judging module 261 judges whether or not data in question is encrypted data. The encryption/decryption processing module 262 refers to a judgment made by the encryption/decryption judging module 261, and encrypts or decrypts data accordingly.

The controller 200, which, in the block diagram of FIG. 1, has both the encryption circuit 280 and the encryption/decryption processing module 262, may have only one of the two.

The encryption control module 263 updates an encryption state management table 251. The encryption control module 263 refers to the updated encryption state management table 251 to control a processing executed by the encryption circuit 280 and the encryption/decryption processing module 262. Specifically, the encryption control module 263 chooses an appropriate encryption key by referring the encryption state management table 251. The encryption control module 263 then instructs the encryption circuit 280 or the encryption/decryption processing module 262 to encrypt or decrypt data with the chosen encryption key.

The encryption key management module 264 manages encryption keys by updating the encryption key management table 265.

The host I/O control module 266 receives I/O from the host computer 500 and performs a processing that fulfills the received I/O. When the received I/O is a write request, for example, the host I/O control module 266 writes write data in one of the LUs 330. When the received I/O is a read request, the host I/O control module 266 reads read data out of one of the LUs 330.

The cache memory 250 temporarily stores the encryption state management table 251, encryption conversion plaintext data 253, and encryption-converted data (encrypted data) 254. The cache memory 250 and the memory 260 may be the same single memory instead of separate memories. The encryption state management table 251 may be stored in the memory 260 instead of the cache memory 250.

The encryption state management table 251 is used to manage whether or not data in a block contained in one LU 330 is encrypted data. Alternatively, the encryption state management table 251 is used to manage whether or not data in a block contained in one LU 330 has been performed rekey processing.

The encryption conversion plaintext data 253 is unencrypted data among data about to be written in the LUs 330 and data read out of the LUs 330. The encryption-converted data 254 is encrypted data among data about to be written in the LUs 330 and data read out of the LUs 330.

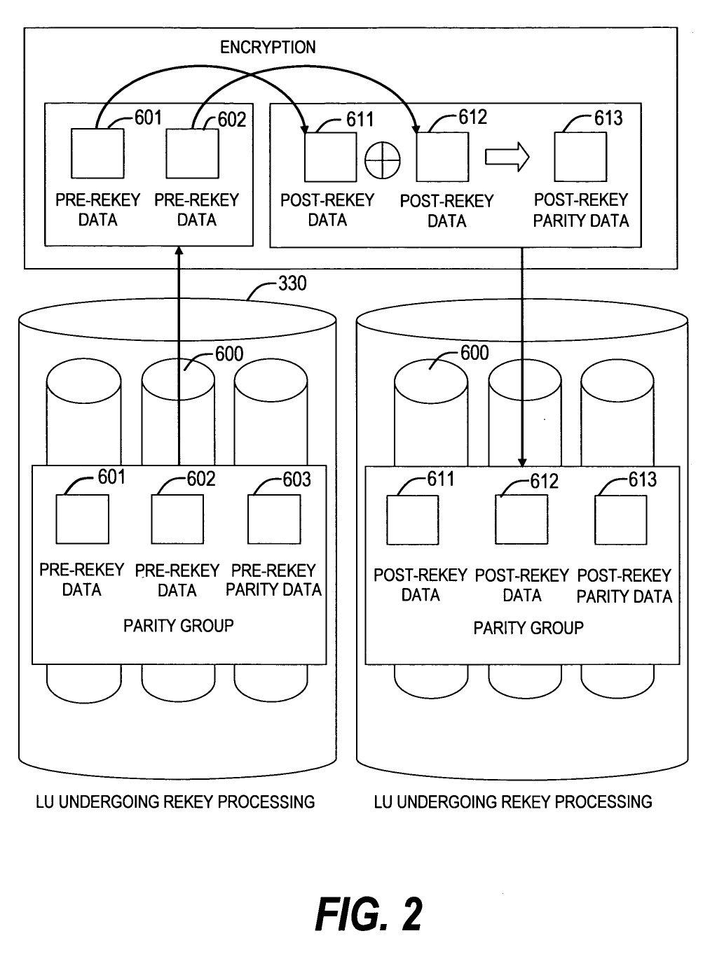

FIG. 2 is an explanatory diagram outlining the rekey processing executed in the computer system according to the embodiment of this invention.

One LU 330 is composed of multiple disk areas 600. The disk areas 600 are storage areas of the disk drives 310 that are provided as the particular LU 330. In other words, one LU 330 is composed of as many disk areas 600 as the count of the disk drives 310 that constitute one RAID group 320.

The controller 200 performs the rekey processing separately on each parity group contained in the LUs 330. A parity group of one LU 330 contains as many pieces of stripe-length data as the count of the disk areas 600 constituting the LU 330. The stripe length is the size of data that is stored in one block contained in the disk areas 600.

To give an example, when one LU 330 is composed of three disk areas 600, a parity group of one LU 330 contains two pieces of data and one piece of parity data. The parity group before receiving the rekey processing accordingly contains pre-rekey data 601, pre-rekey data 602, and pre-rekey parity data 603.

The controller 200 first reads other data than parity data out of the rekey processing target parity group. In this example, the controller 200 reads the pre-rekey data 601 and the pre-rekey data 602. The controller 200 next uses a pre-rekey encryption key to decrypt the read pre-rekey data 601 and pre-rekey data 602. The controller 200 then stores the decrypted pre-rekey data 601 and pre-rekey data 602 in the cache memory 250 as the encryption conversion plaintext data 253.

The controller 200 next uses a post-rekey encryption key to encrypt the pre-rekey data 601 and pre-rekey data 602 stored in the cache memory 250. The controller 200 thus converts the pre-rekey data 601 and the pre-rekey data 602 into post-rekey data 611 and post-rekey data 612.

From the post-rekey data 611 and post-rekey data 612 created by the conversion, the controller 200 creates parity data (post-rekey parity data) 613.

The controller 200 stores the post-rekey data 611 and post-rekey data 612 created by the conversion and the created post-rekey parity data 613 in the cache memory 250 as the encryption-converted data 254.

The controller 200 then writes the post-rekey data 611, post-rekey data 612, and post-rekey parity data 613 stored in the cache memory 250 back to the rekey processing target parity group.

The controller 200 hereby completes the rekey processing of one parity group.

FIG. 3 is a configuration diagram showing the encryption key management table 265 which is stored in the controller 200 according to the embodiment of this invention.

The encryption key management table 265 contains in each of its record entries an encryption key name 2651, a RAID group number 2652, a LUN 2653, and a key creation year/month/day/time 2654.

The encryption key name 2651 indicates an identifier unique to each encryption key. The RAID group number 2652 indicates an identifier unique to the RAID group 320 that contains the LU 330 encrypted by an encryption key that is identified by the encryption key name 2651 of the record in question.

The LUN 2653 indicates an identifier unique to the LU 330 encrypted by an encryption key that is identified by the encryption key name 2651 of the record in question. The key creation year/month/day/time 2654 indicates the time an encryption key that is identified by the encryption key name 2651 of the record in question has been created.

FIG. 4 is a configuration diagram showing the encrypted area management table 267 which is stored in the controller 200 according to the embodiment of this invention.

The encrypted area management table 267 contains in each of its record entries a RAID group number 2671, a LUN 2672, an encryption key name 2673, and an encryption attribute 2674.

The LUN 2672 indicates an identifier unique to each LU 330 provided by the storage system 100. The RAID group number 2671 indicates an identifier unique to the RAID group 320 to which the LU 330 identified by the LUN 2672 of the record in question belongs.

The encryption key name 2673 indicates an identifier unique to an encryption key that is used in encrypting the LU 330 identified by the LUN 2672 of the record in question. In the case where data stored in the LU 330 identified by the LUN 2672 of the record in question is unencrypted data, no value is held as the encryption key name 2673. The encryption attribute 2674 indicates whether or not the LU 330 identified by the LUN 2672 of the record in question has been encrypted.

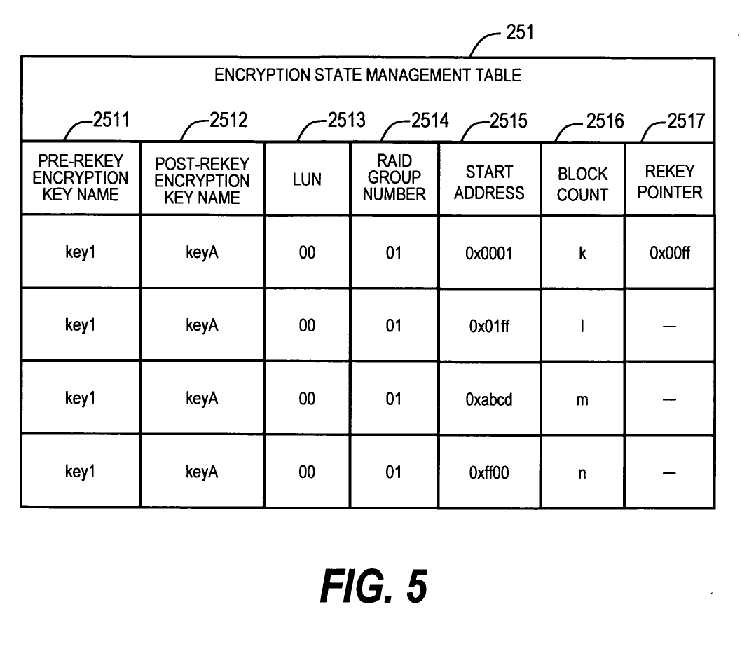

FIG. 5 is a configuration diagram showing the encryption state management table 251 which is stored in the controller 200 according to the embodiment of this invention.

One encryption state management table 251 is associated with one rekey target LU 330. Each encryption state management table 251 contains in each of its record entries a pre-rekey encryption key name 2511, a post-rekey encryption key name 2512, a LUN 2513, a RAID group number 2514, a start address 2515, a block count 2516, and a rekey pointer 2517.

The LUN 2513 indicates an identifier unique to the rekey target LU 330. The RAID group number 2514 indicates an identifier unique to the RAID group 320 to which the LU 330 identified by the LUN 2513 of the record in question belongs.

The pre-rekey encryption key name 2511 indicates an identifier unique to an encryption key that is used, before performing rekey processing, to encrypt the LU 330 identified by the LUN 2513 of the record in question. The post-rekey encryption key name 2512 indicates an identifier unique to an encryption key that is used, after performing rekey processing, to encrypt the LU 330 identified by the LUN 2513 of the record in question.

The start address 2515 indicates the address of a performed rekey processing block among blocks that are contained in the LU 330 identified by the LUN 2513 of the record in question. In the case where rekey processed blocks have successive addresses, the address of the block that is at the head of the successive blocks is stored as the start address 2515.

Stored as the block count 2516 is the count of rekey processed blocks that have successive addresses. The block count 2516 indicates how many successive blocks follow a block that is indicated by the start address 2515 of the record in question.

The rekey pointer 2517 indicates which block is being performed rekey processing among blocks that are contained in the LU 330 identified by the LUN 2513 of the record in question. The controller 200 performs rekey processing of blocks contained in the LU 330 in order of block address.

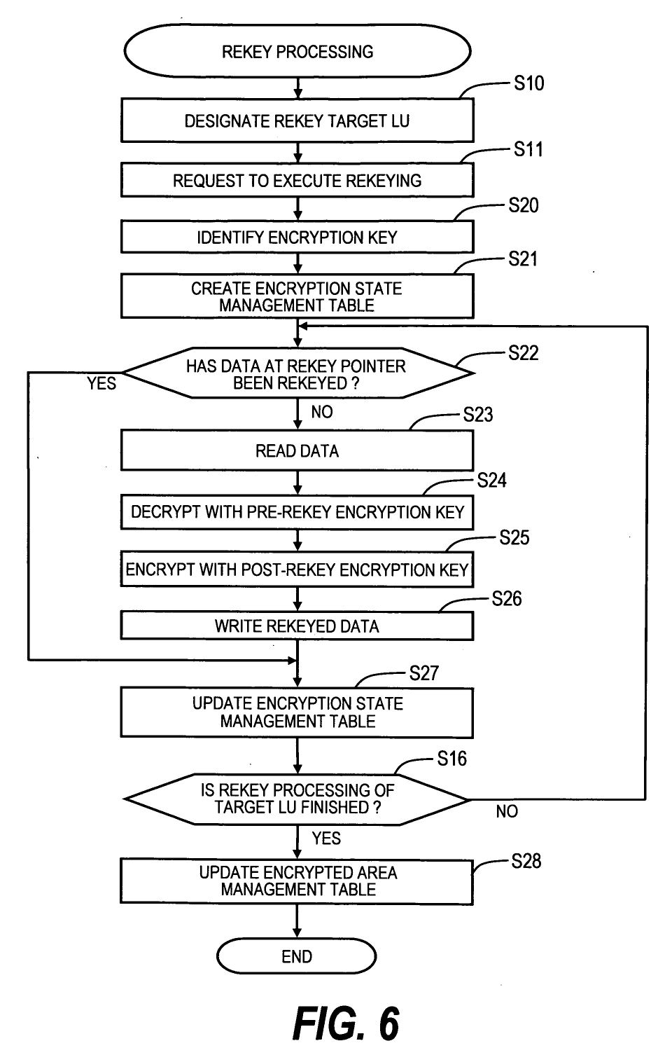

FIG. 6 is a flow chart of the rekey processing executed by the computer system according to the embodiment of this invention.

First, the management computer 400 displays a rekey instruction screen 420.

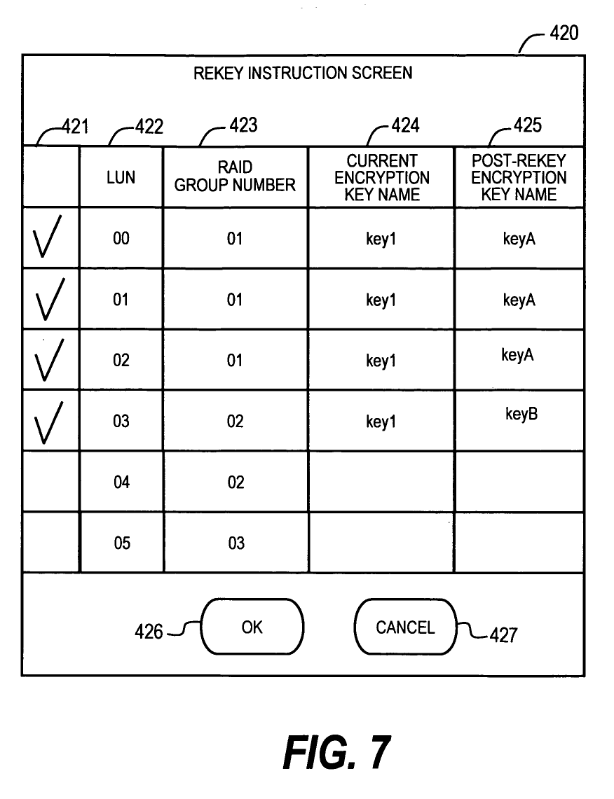

FIG. 7 is an explanatory diagram showing the rekey instruction screen 420 which is displayed on the management computer 400 according to the embodiment of this invention.

The rekey instruction screen 420 contains a rekey target LU selection table, an OK button 426, and a cancel button 427.

The rekey target LU selection table contains in each of its record entries a rekey target checkbox 421, a LUN 422, a RAID group number 423, a current encryption key name 424, and a post-rekey encryption key name 425.

The LUN 422 indicates an identifier unique to each LU 330 that can be a rekey target. The RAID group number 423 indicates an identifier unique to the RAID group 320 to which the LU 330 identified by the LUN 422 of the record in question belongs.

The current encryption key name 424 indicates an identifier unique to an encryption key that is currently used to encrypt the LU 330 identified by the LUN 422 of the record in question. In the case where data stored in the LU 330 identified by the LUN 422 of the record in question is unencrypted data, no value is held as the current encryption key name 424.

The post-rekey encryption key name 425 indicates an identifier unique to an encryption key that is used after the rekey processing is finished for the LU 330 identified by the LUN 422 of the record in question. An identifier indicated by the post-rekey encryption key name 425 is the identifier of a post-rekey encryption key which is determined by the management computer 400, the storage system 100, or an administrator. In the case where it is the administrator that assigns a post-rekey encryption key, a field for the post-rekey encryption key name 425 is replaced with a field for entering the identifier of a post-rekey encryption key.

The rekey target checkbox 421 is used to designate as a rekey target the LU 330 identified by the LUN 422 of the record in question.

When the OK button 426 is operated by the administrator, the management computer 400 chooses a record whose rekey target designation field 421 is checked. From the chosen record, the management computer 400 extracts the LUN 422. The management computer 400 treats the LU 330 that is identified by the extracted LUN 422 as a rekey target.

When the cancel button 427 is operated, the management computer 400 stops displaying the rekey instruction screen 420.

How the rekey instruction screen 420 is created will be described next.

The management computer 400 first obtains the encrypted area management table 267 from the storage system 100. The management computer 400 then creates the rekey instruction screen 420 based on the obtained encrypted area management table 267.

Specifically, the management computer 400 stores the LUN 2672 of the obtained encrypted area management table 267 as the LUN 422 in the rekey instruction screen 420. The management computer 400 next stores the RAID group number 2671 of the obtained encrypted area management table 267 as the RAID group number 423 in the rekey instruction screen 420. The management computer 400 then stores the encryption key name 2673 of the obtained encrypted area management table 267 as the current encryption key name 424 in the rekey instruction screen 420.

Thereafter, the management computer 400 decides on a post-rekey encryption key. The management computer 400 stores the identifier of the decided encryption key as the post-rekey encryption key name 425 in the rekey instruction screen 420.

The management computer 400 creates the rekey instruction screen 420 in this manner. The rekey instruction screen 420 may be created by the storage system 100 instead of the management computer 400. In this case, the management computer 400 receives the rekey instruction screen 420 created by the storage system 100, and displays the received rekey instruction screen 420. Also, a post-rekey encryption key may be determined by the storage system 100 instead of the management computer 400. In this case, the management computer 400 receives a post-key encryption key determined by the storage system 100, and displays the received post-rekey encryption key in the rekey instruction screen 420.

The description now returns to FIG. 6.

The management computer 400 receives the LUN designated by the administrator as a rekey target (S10).

The management computer 400 sends a request to the storage system 100 to execute the rekey processing of the designated LU 330 (S11). The rekey processing execution request contains the LUN 422, the RAID group number 423, the current encryption key name 424, and the post-rekey encryption key name 425 that are extracted from a record in the rekey instruction screen 420 whose rekey target checkbox 421 is checked.

In the case where the administrator designates more than one rekey target LU 330 at once, the following processing is performed separately on each rekey target LU 330.

The storage system 100 receives the rekey processing execution request. From the received rekey processing execution request, the storage system 100 extracts the LUN 422, the RAID group number 423, the current encryption key name 424, and the post-rekey encryption key name 425.

The storage system 100 then identifies the received rekey processing execution request as a request to make a switch from an encryption key that is identified by the extracted current encryption key name 424 to an encryption key that is identified by the extracted post-rekey encryption key name 425 (S20).

Next, the storage system 100 creates the encryption state management table 251 (S21).

The storage system 100 stores the extracted current encryption key name 424 as the pre-rekey encryption key name 2511 in the created encryption state management table 251. The storage system 100 stores the extracted post-rekey encryption key name 425 as the post-rekey encryption key name 2512 in the created encryption state management table 251.

The storage system 100 stores the extracted LUN 422 as the LUN 2513 in the created encryption state management table 251. The storage system 100 stores the extracted RAID group number 423 as the RAID group number 2514 in the created encryption state management table 251.

The storage system 100 stores an address indicating the position of the head block of the LU 330 that is identified by the extracted LUN 422 as the start address 2515 and the rekey pointer 2517 in the created encryption state management table 251. The storage system 100 stores “0” as the block count 2516 in the created encryption state management table 251.

Thereafter, the storage system 100 extracts the rekey pointer 2517 from the encryption state management table 251. The storage system 100 judges whether or not data in a block that is indicated by the extracted rekey pointer 2517 has been performed rekey processing (S22).

Specifically, the storage system 100 adds the block count 2516 to the start address 2515 of the encryption state management table 251. The storage system 100 thus calculates an end address which is the address of the last block of successive blocks that have been performed rekey processing.

The storage system 100 next judges whether or not the encryption state management table 251 has a record in which the extracted rekey pointer 2517 falls between the start address 2515 and the calculated end address.

When the encryption state management table 251 has such a record, the storage system 100 judges that data in a block that is indicated by the extracted rekey pointer 2517 has been performed rekey processing. Then the storage system 100 proceeds directly to Step S27.

When the encryption state management table 251 does not have such a record, the storage system 100 judges that data in a block that is indicated by the extracted rekey pointer 2517 has not been performed rekey processing.

Then the storage system 100 reads data (pre-rekey data) out of the block indicated by the extracted rekey pointer 2517 (S23). The storage system 100 decrypts the read pre-rekey data with an encryption key that is identified by the extracted current encryption key name 424 (S24). The storage system 100 stores the decrypted pre-rekey data in the cache memory 250 as the encryption conversion plaintext data 253.

Next, the storage system 100 encrypts the pre-rekey data stored in the cache memory 250 with an encryption key that is identified by the extracted post-rekey encryption key name 425 (S25). The storage system 100 thus converts the pre-rekey data into post-rekey data.

The storage system 100 stores the post-rekey data created by the conversion in the cache memory 250 as the encryption-converted data 254.

The storage system 100 then writes the post-rekey data stored in the cache memory 250 back to the block indicated by the extracted rekey pointer 2517 (S26).

Thereafter, the storage system 100 updates the encryption state management table 251 (S27).

Specifically, the storage system 100 adds “1” to the rekey pointer 2517. The storage system 100 then judges whether or not the encryption state management table 251 has a record whose start address 2515 matches the rekey pointer 2517 after “1” is added.

When there is no record that meets the condition, the storage system 100 proceeds directly to Step S16.

On the other hand, when there is a record that meets the condition, the storage system 100 chooses this record and extracts the block count 2516 from the chosen record. The storage system 100 then deletes the chosen record from the encryption state management table 251. The storage system 100 adds the extracted block count 2516 to the rekey pointer 2517 of the encryption state management table 251.

The storage system 100 updates the encryption state management table 251 in this manner.

Next, the storage system 100 judges whether or not the rekey pointer 2517 of the encryption state management table 251 indicates the position of the last block of the rekey target LU 330. The storage system 100 thus judges whether or not the rekey processing of the rekey target LU 330 has been completed (S16).

When the rekey pointer 2517 does not indicate the position of the last block of the rekey target LU 330, it means that the rekey processing of the rekey target LU 330 has not been completed yet. Then the storage system 100 returns to Step S22 to repeat the processing.

On the other hand, when the rekey pointer 2517 indicates the position of the last block of the rekey target LU 330, it means that the rekey processing of the rekey target LU 330 has been completed. Then the storage system 100 updates the encrypted area management table 267 (S28).

Specifically, the storage system 100 chooses from the encrypted area management table 267 a record whose LUN 2672 matches the LUN 422 (the identifier of the rekey target LU 330) extracted in Step S20. The storage system 100 stores the post-rekey encryption key name 425 extracted in Step S20 in the chosen record as the encryption key name 2673.

The storage system 100 updates the encrypted area management table 267 in this manner. The storage system 100 then ends this rekey processing.

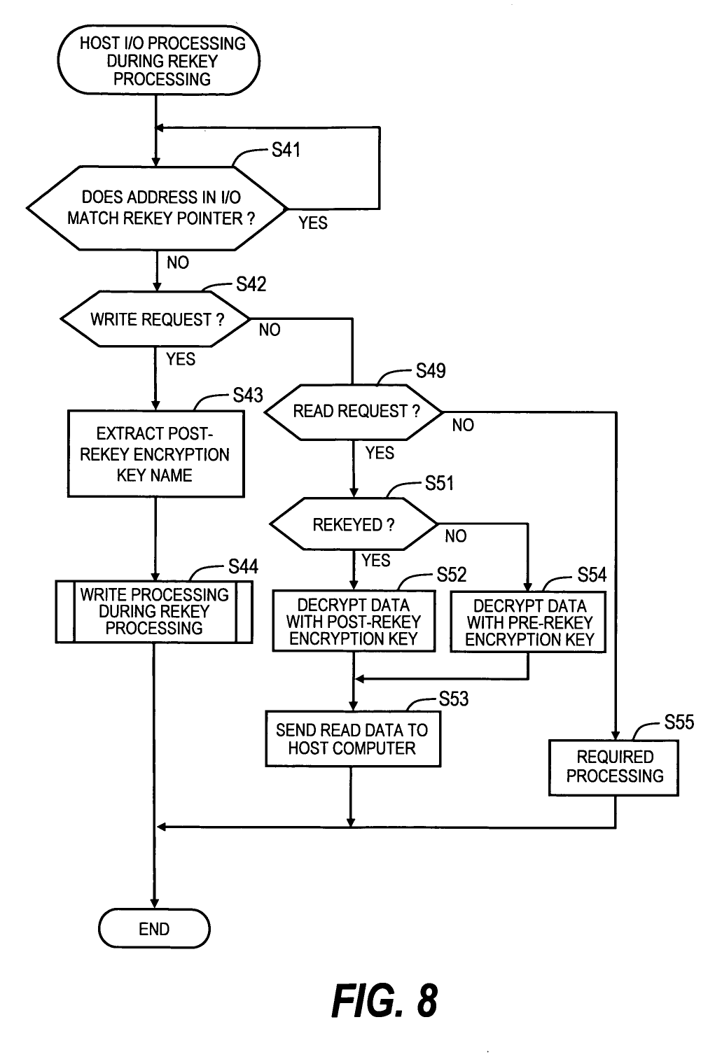

FIG. 8 is a flow chart of a host I/O processing that is executed during the rekey processing by the storage system 100 according to the embodiment of this invention.

The storage system 100 executes this host I/O processing during the rekey processing when I/O directed to the LU 330 on which the rekey processing is being performed is received from the host computer 500.

First, the storage system 100 extracts from the received I/O the address of a block to which the I/O is directed. Next, the storage system 100 judges whether or not the extracted address matches the rekey pointer 2517 of the encryption state management table 251 (S41). The storage system 100 thus judges whether or not data in the I/O target block is being performed rekey processing.

When the extracted address matches the rekey pointer 2517 of the encryption state management table 251, it means that data in the I/O target block is being performed rekey processing. Then the storage system 100 stands by until the extracted address no longer matches the rekey pointer 2517 of the encryption state management table 251.

On the other hand, when the extracted address does not match the rekey pointer 2517 of the encryption state management table 251, it means that data in the I/O target block is not being performed rekey processing. Then the storage system 100 judges whether or not the received I/O is a write request (S42).

In the case where the received I/O is a write request, the storage system 100 identifies which encryption state management table 251 is associated with the LU 330 where data is requested to be written. From the identified encryption state management table 251, the storage system 100 extracts the post-rekey encryption key name 2512 (S43).

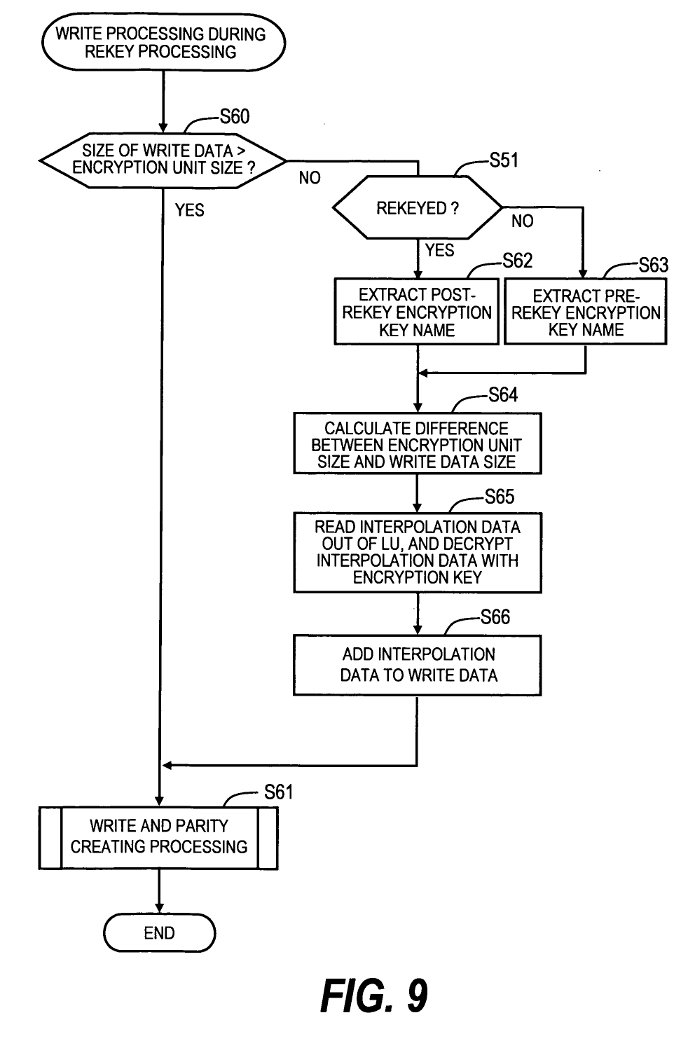

The storage system 100 next executes a write processing that is executed during the rekey processing (S44). Details of the write processing during the rekey processing will be described with reference to FIG. 9.

The storage system 100 then ends this host I/O processing during the rekey processing.

In the case where the received I/O is not a write request, the storage system 100 judges whether or not the received I/O is a read request (S49).

When the received I/O is not a read request, the storage system 100 executes a processing that fulfills the received I/O (S55). The storage system 100 then ends this host I/O processing during the rekey processing.

On the other hand, when the received I/O is a read request, the storage system 100 judges whether or not data in the I/O target block has been performed rekey processing (S51).

Specifically, the storage system 100 judges whether or not the extracted address of the I/O target block is equal to or smaller than the rekey pointer 2517 of the encryption state management table 251.

When the address of the I/O target block is equal to or smaller than the rekey pointer 2517 of the encryption state management table 251, it means that data in the I/O target block has been performed rekey processing. Then the storage system 100 extracts the post-rekey encryption key name 2512 from the encryption state management table 251.

Next, the storage system 100 reads data out of the I/O target block. The storage system 100 decrypts the read data with an encryption key that is identified by the extracted post-rekey encryption key name 2512 (S52).

The storage system 100 sends the decrypted read data to the host computer 500 which has sent the I/O request (S53). The storage system 100 then ends this host I/O processing during the rekey processing.

When the address of the I/O target block is larger than the rekey pointer 2517 of the encryption state management table 251, the storage system 100 adds the block count 2516 to the start address 2515 of the encryption state management table 251. The storage system 100 thus calculates an end address which is the address of the last block of successive blocks that have been performed rekey processing.

The storage system 100 next judges whether or not the encryption state management table 251 has a record in which the extracted address of the I/O target block falls between the start address 2515 and the calculated end address.

When the encryption state management table 251 has such a record, it means that data in the I/O target block has been performed rekey processing. Then the storage system 100 extracts the post-rekey encryption key name 2512 from the encryption state management table 251.

The storage system 100 next reads data out of the I/O target block. The storage system 100 decrypts the read data with an encryption key that is identified by the extracted post-rekey encryption key name 2512 (S52).

The storage system 100 sends the decrypted read data to the host computer 500 which has sent the I/O request (S53). The storage system 100 then ends this host I/O processing during the rekey processing.

When the encryption state management table 251 does not have a record that meets the condition, it means that data in the I/O target block has not been performed rekey processing. Then the storage system 100 extracts the pre-rekey encryption key name 2511 from the encryption state management table 251.

The storage system 100 next reads data out of the I/O target block. The storage system 100 decrypts the read data with an encryption key that is identified by the extracted pre-rekey encryption key name 2511 (S54).

The storage system 100 sends the decrypted read data to the host computer 500 which has sent the I/O request (S53). The storage system 100 then ends this host I/O processing during the rekey processing.

FIG. 9 is a flow chart of a write processing that is executed during the rekey processing by the storage system 100 according to the embodiment of this invention.

As shown in FIG. 8, the write processing during the rekey processing is executed in Step S44 of the host I/O processing during the rekey processing.

First, the storage system 100 identifies the size of data that is requested to be written by the I/O received in Step S41 of the host I/O processing during the rekey processing. Next, the storage system 100 judges whether or not the identified size of the write data is larger than the encryption unit size (S60). The encryption unit size is the size of data to be encrypted. The encryption unit size in this embodiment is equal to the size of data stored in one block.

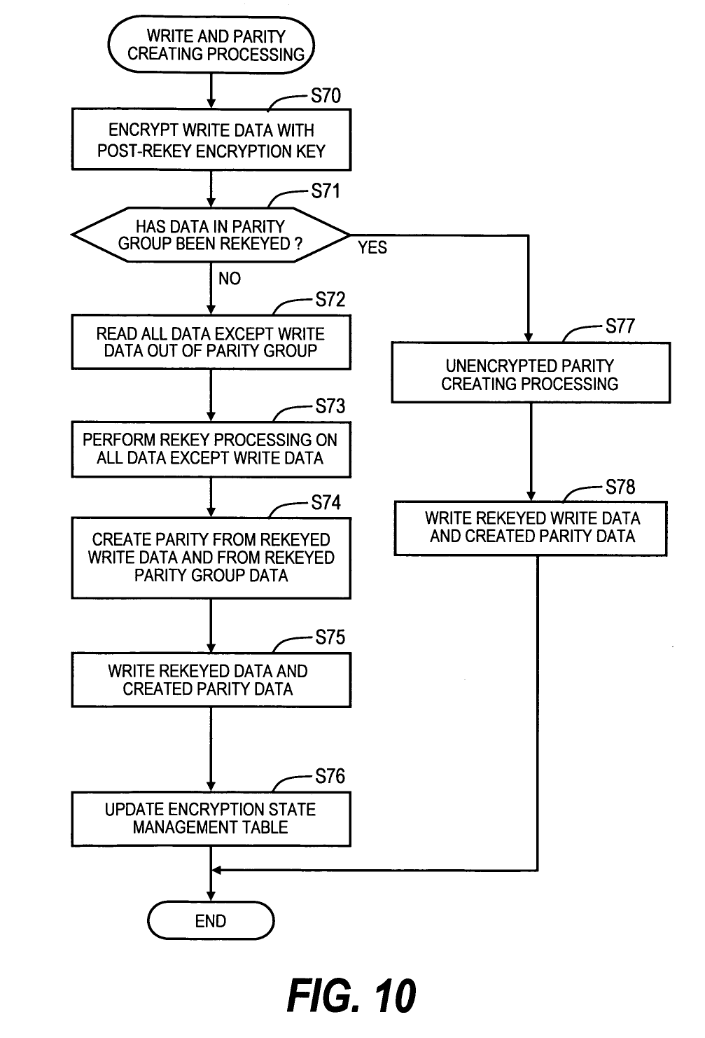

In the case where the size of the write data is larger than the encryption unit size, the storage system 100 performs a write and parity creating processing (S61). Details of the write and parity creating processing will be described with reference to FIG. 10.

The storage system 100 then ends this write processing during the rekey processing.

In the case where the size of the write data is equal to or smaller than the encryption unit size, the storage system 100 judges whether or not data in the I/O target block has been performed rekey processing (S51).

Specifically, the storage system 100 judges whether or not the address extracted as the address of the I/O target block in Step S41 of the host I/O processing during the rekey processing is equal to or smaller than the rekey pointer 2517 of the encryption state management table 251.

When the address of the I/O target block is equal to or smaller than the rekey pointer 2517 of the encryption state management table 251, it means that data in the I/O target block has been performed rekey processing. Then the storage system 100 extracts the post-rekey encryption key name 2512 from the encryption state management table 251 (S62).

When the address of the I/O target block is larger than the rekey pointer 2517 of the encryption state management table 251, the storage system 100 adds the block count 2516 to the start address 2515 of the encryption state management table 251. The storage system 100 thus calculates an end address which is the address of the last block of successive blocks that have been performed rekey processing.

The storage system 100 next judges whether or not the encryption state management table 251 has a record in which the extracted address of the I/O target block falls between the start address 2515 and the calculated end address.

When the encryption state management table 251 has such a record, it means that data in the I/O target block has been performed rekey processing. Then the storage system 100 extracts the post-rekey encryption key name 2512 from the encryption state management table 251 (S62).

When the encryption state management table 251 does not have such a record, it means that data in the I/O target block has not been performed rekey processing. Then the storage system 100 extracts the pre-rekey encryption key name 2511 from the encryption state management table 251 (S63).

Next, the storage system 100 calculates the difference between the write data size identified in Step S60 and the encryption unit size (S64).

The storage system 100 reads as much data (interpolation data) as the calculated difference out of the I/O target block contained in the LU 330 on which the rekey processing is being performed (S65).

The storage system 100 decrypts the read interpolation data with an encryption key that is identified by the post-rekey encryption key name 2512 extracted in Step S62 or with the pre-rekey encryption key name 2511 extracted in Step S63.

The storage system 100 adds the decrypted interpolation data to the write data (S66). Next, the storage system 100 performs the write and parity creating processing (S61). Details of the write and parity creating processing will be described with reference to FIG. 10.

The storage system 100 then ends this write processing during the rekey processing.

FIG. 10 is a flow chart for showing the write and parity creating processing of the storage system 100 according to the embodiment of this invention.

As shown in FIG. 9, the write and parity creating processing is executed in Step S61 of the write processing during the rekey processing.

First, the storage system 100 encrypts the write data with an encryption key that is identified by the post-rekey encryption key name 2512 extracted in Step S43 of the host I/O processing during the rekey processing (S70). In the case where the size of the write data is judged as equal to or smaller than the encryption unit size in Step S60 of the write processing during the rekey processing, the write data encrypted in Step S70 is write data to which interpolation data has been added.

Next, the storage system 100 judges whether or not every piece of data contained in the same parity group as data in the I/O target block has been performed rekey processing (S71).

Specifically, the storage system 100 identifies the address of every block that stores data contained in the same parity group as data in the I/O target block. The storage system 100 judges whether or not the largest of the identified addresses is equal to or smaller than the rekey pointer 2517 of the encryption state management table 251.

When the largest of the identified addresses is equal to or smaller than the rekey pointer 2517 of the encryption state management table 251, it means that every piece of data contained in this parity group has been performed rekey processing. Then the storage system 100 performs an unencrypted parity creating processing (S77).

Specifically, the storage system 100 reads data contained in this parity group out of the LU 330. The storage system 100 creates parity data from the read data and from the write data (write data performed rekey processing) encrypted in Step S70.

The storage system 100 writes the write data performed rekey processing and the created parity data in the LU 330 (S78). The storage system 100 then ends the write and parity creating processing.

When the largest of the identified addresses is larger than the rekey pointer 2517 of the encryption state management table 251, the storage system 100 adds the block count 2516 to the start address 2515 of the encryption state management table 251. The storage system 100 thus calculates an end address which is the address of the last block of successive blocks that have been performed rekey processing.

The storage system 100 next judges whether or not the encryption state management table 251 has a record in which all the identified addresses fall between the start address 2515 and the calculated end address.

When the encryption state management table 251 has such a record, it means that every piece of data contained in this parity group has been performed rekey processing. Then the storage system 100 performs the unencrypted parity creating processing (S77). The storage system 100 thus creates parity data.

The storage system 100 writes the write data performed rekey processing and the created parity data in the LU 330 (S78). The storage system 100 then ends the write and parity creating processing.

When the encryption state management table 251 does not have a record that meets the condition, it means that at least a part of data contained in this parity group has not been performed rekey processing yet. Then the storage system 100 reads out of the LU 330 every piece of data contained in this parity group except data in the I/O target block (S72).

Next, the storage system 100 performs the rekey processing on the read data (S73).

Specifically, the storage system 100 extracts the pre-rekey encryption key name 2511 and the post-rekey encryption key name 2512 from the encryption state management table 251. The storage system 100 decrypts the read data with an encryption key that is identified by the extracted pre-rekey encryption key name 2511. The storage system 100 then encrypts the decrypted data with an encryption key that is identified by the extracted post-rekey encryption key name 2512. The storage system 100 thus creates parity group data performed rekey processing.

From the created parity group data performed rekey processing and from the write data (write data performed rekey processing) encrypted in Step S70, the storage system 100 creates parity data (S74).

The storage system 100 writes the write data performed rekey processing and the crated parity data in the LU 330 (S75). The storage system 100 then ends the write and parity creating processing.

Next, the storage system 100 updates the encryption state management table 251 of FIG. 5.

Specifically, the storage system 100 adds a new record to the encryption state management table 251. In the new record, the storage system 100 stores the same values that are held in other records of the encryption state management table 251 as the pre-rekey encryption key name 2511, the post-rekey encryption key name 2512, the LUN 2513, and the RAID group number 2514. As the start address 2515 of the new record, the storage system 100 stores the smallest of the addresses identified in Step S71. The storage system 100 stores the count of pieces of data constituting the parity group as the block count 2516 of the new record.

The storage system 100 updates the encryption state management table 251 in this manner. The storage system 100 then ends the write and parity creating processing.

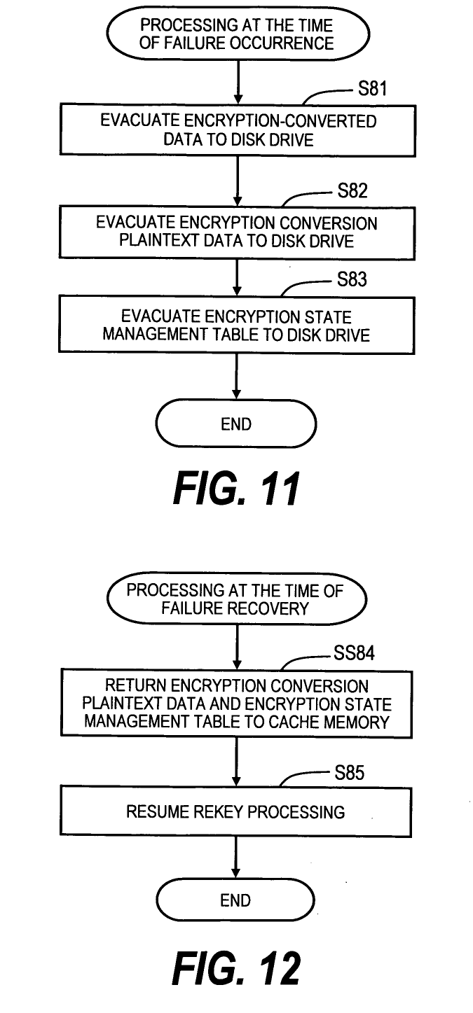

FIG. 11 is a flow chart of a processing at the time of failure occurrence of the storage system 100 according to the embodiment of this invention.

The storage system 100 executes the processing at the time of failure occurrence when a failure is detected during the rekey processing.

First, the storage system 100 interrupts the rekey processing. Next, the storage system 100 evacuates the encryption-converted data 254 from the cache memory 250 to an evacuation area in the disk drives 310 (S81).

The storage system 100 next starts to destage the encryption conversion plaintext data 253 from the cache memory 250 to the evacuation area in the disk drives 310 (S82). The storage system 100 also starts to destage the encryption state management table 251 from the cache memory 250 to the evacuation area in the disk drives 310 (S83).

The storage system 100 then ends the processing at the time of failure occurrence.

FIG. 12 is a flow chart of a processing at the time of failure recovery of the storage system 100 according to the embodiment of this invention.

The storage system 100 executes this processing at the time of failure recovery when recovery from a failure is detected.

First, the storage system 100 restores the encryption conversion plaintext data 253 and the encryption state management table 251 that have been performed destage from the disk drives 310 to the cache memory 250 (S84). Next, the storage system 100 resumes the rekey processing, starting at an address that is indicated by the rekey pointer 2517 of the encryption state management table 251 (S85). The storage system 100 then ends the processing at the time of failure recovery.

As described above, according to this embodiment, the storage system 100 performs the rekey processing on write data before writing the data in one of the LUs 330 in the case where a write request is received during the rekey processing. Also, the storage system 100 performs the rekey processing on data that is contained in the same parity group as data in a block where the write data is requested to be written. The storage system 100 of this embodiment therefore does not need to perform the rekey processing anew on the write data. The performance degradation of the storage system 100 is thus reduced.

The description given in this embodiment is about the rekey processing, and the same applies to the encryption processing in which plaintext is converted into ciphertext.

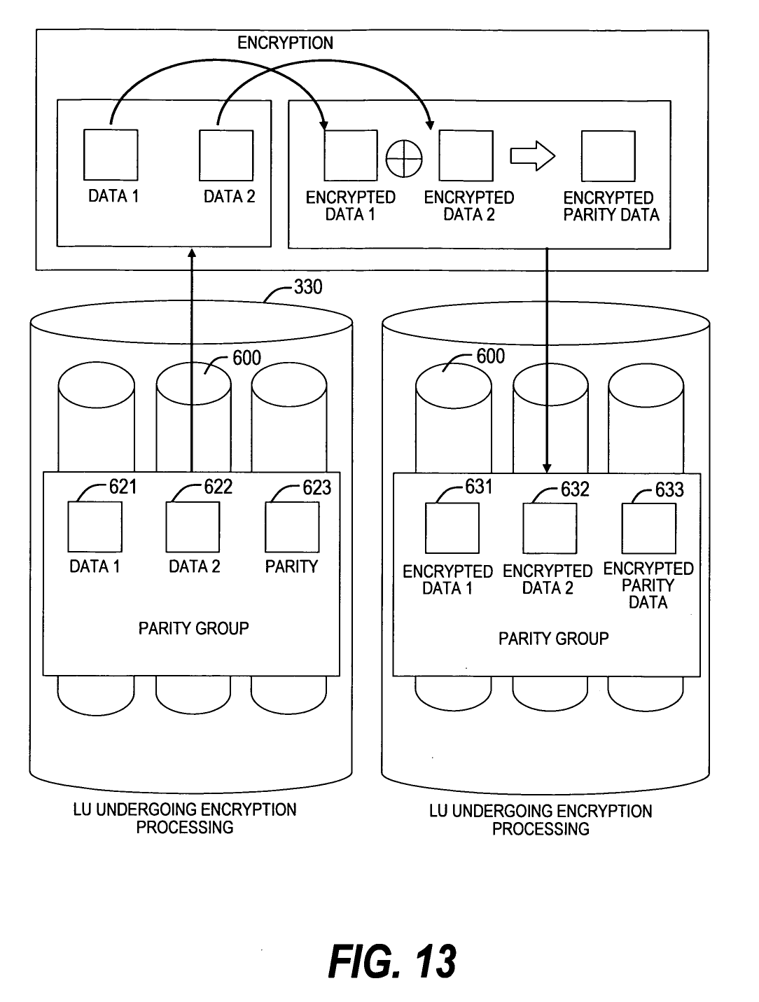

FIG. 13 is an explanatory diagram outlining an encryption processing executed by the computer system according to the embodiment of this invention.

One LU 330 is composed of multiple disk areas 600. The disk areas 600 are storage areas of the disk drives 310 that are provided as the particular LU 330. In other words, one LU 330 is composed of as many disk areas 600 as the count of the disk drives 310 that constitute one RAID group 320.

The controller 200 performs the encryption processing separately on each parity group contained in the LUs 330. A parity group of one LU 330 contains as many pieces of stripe-length data as the count of the disk areas 600 constituting the LU 330. The stripe-length data is data that is stored in one block contained in the disk areas 600.

To give an example, when one LU 330 is composed of three disk areas 600, a parity group of this LU 330 contains two pieces of data and one piece of parity data. Before encrypted, the parity group contains data 621, data 622, and parity data 623.

The controller 200 first reads other data than parity data out of an encryption processing target parity group. In this example, the controller 200 reads the data 621 and the data 622.

The controller 200 stores the read data 621 and data 622 in the cache memory 250 as the encryption conversion plaintext data 253.

The controller 200 next uses an encryption key to encrypt the data 621 and data 622 stored in the cache memory 250. The controller 200 thus converts the data 621 and the data 622 into encrypted data 631 and encrypted data 632.

From the encrypted data 631 and the encrypted data 632 which have been created by the conversion, the controller 200 creates parity data (encrypted parity data) 633.

The controller 200 stores the encrypted data 631 and the encrypted data 632 which have been created by the conversion and the created encrypted parity data 633 in the cache memory 250 as the encryption-converted data 254.

The controller 200 then writes the encrypted data 631, encrypted data 632, and encrypted parity data 633 stored in the cache memory 250 back to the encryption processing target parity group.

The controller 200 hereby completes the encryption processing of one parity group.

Accordingly, in the encryption processing, the controller 200 does not decrypt the data 621 and the data 622 with an encryption key (an encryption key assigned before performing rekey processing). The rest of the processing except the processing described in the encryption processing is the same as the rekey processing, and its description will be omitted.

As described above, the storage system 100 encrypts write data before writing the data in one of the LUs 330 in the case where a write request is received during the encryption processing. Also, the storage system 100 performs the encryption processing on data that is contained in the same parity group as data in a block where the write data is requested to be written. The storage system 100 of this embodiment therefore does not need to perform the encryption processing anew on the write data. The performance degradation of the storage system 100 is thus reduced.

While the present invention has been described in detail and pictorially in the accompanying drawings, the present invention is not limited to such detail but covers various obvious modifications and equivalent arrangements, which fall within the purview of the appended claims.

What is claimed is:

1. A storage system connected to a host computer, comprising:
a disk drive which stores data requested by the host computer to be written; and
a disk controller which controls data read and data write to the disk drive,
wherein the disk controller is configured to:
provide a storage area of the disk drive to the host computer as at least one logical volume;
execute a processing of switching an encryption key that is used to encrypt data stored in the logical volume from a first encryption key to a second encryption key;
encrypt write data which is requested to be written by a received write request with the second encryption key when the write request for one of storage areas within the logical volume that stores data for which switching of encryption keys has not been finished is received while the encryption key switching processing is being executed; and
write the encrypted write data in the logical volume to switch encryption keys for data stored in the storage area where the data is requested to be written by the received write request.

2. The storage system according to claim 1, wherein the disk controller is further configured to:
judge whether switching of encryption keys has been finished for other data included in a parity group to which the data stored in the storage area where the data is requested to be written by the received write request belongs;
read the other data out of the logical volume when it is judged that switching of encryption keys has not been finished for the other data;
decrypt the read other data with the first encryption key;
encrypt the decrypted other data with the second encryption key; and
write the encrypted other data in the logical volume to switch encryption keys of the other data.

3. The storage system according to claim 2, wherein the disk controller is further configured to:
create parity data from the write data and the other data which have been encrypted with the second encryption key; and
write the created parity data in the logical volume.

4. The storage system according to claim 1, wherein the disk controller is further configured to:
judge whether switching from the first encryption key to the second encryption key has been finished for other data included in a parity group to which the data stored in the storage area where the data is requested to be written by the received write request belongs;
read the other data encrypted with the second encryption key out of the logical volume when it is judged that the switching of the encryption keys has been finished for the other data;
create parity data from the write data and the other data which have been encrypted with the second encryption key; and
write the created parity data in the logical volume.

5. The storage system according to claim 1, wherein the storage system stores encryption state management information which indicates whether switching of encryption keys has been finished for data stored in a storage area within the logical volume.

6. The storage system according to claim 1, wherein, upon reception of a write request for one of storage areas within the logical volume that stores data on which switching of encryption keys is being performed, the disk controller is further configured to wait for the data to finish switching encryption keys before executing a processing that fulfills the received write request.

7. A storage system coupled to a host computer, comprising:
a disk drive which stores data requested by the host computer to be written; and
a disk controller which controls data read and data write to the disk drive,
wherein the disk controller is configured to:
provide a storage area of the disk drive to the host computer as at least one logical volumes;
execute a processing of encrypting data that the logical volume stores with an encryption key;
encrypt write data which is requested to be written by a received write request using the encryption key, when the write request for one of storage areas within the logical volume that stores unencrypted data is received while the encryption processing is being executed; and
write the encrypted write data in the logical volume to encrypt data stored in the storage area where the data is requested to be written by the received write request.

8. The storage system according to claim 7, wherein the disk controller is further configured to:
judge whether encryption has been finished for other data included in a parity group to which the data stored in the storage area where the data is requested to be written by the received write request belongs;
read the other data out of the logical volume when it is judged that encryption has not been finished for the other data;
encrypt the read other data with the encryption key; and
write the encrypted other data in the logical volume to encrypt the other data.

9. The storage system according to claim 8, wherein the disk controller is further configured to:
create parity data from the write data and the other data which have been encrypted with the encryption key; and
write the created parity data in the logical volume.

10. The storage system according to claim 8, wherein the disk controller is further configured to:
judge whether encryption has been finished for other data included in a parity group to which the data stored in the storage area where the data is requested to be written by the received write request belongs;
read the encrypted other data out of the logical volume when it is judged that the encryption has been finished for the other data;
create parity data from the write data and the other data which have, been encrypted; and
write the created parity data in the logical volume.

11. The storage system according to claim 7, wherein the storage system stores encryption state management information which indicates whether encryption has been finished for data stored in a storage area within the logical volume.

12. The storage system according to claim 7, wherein, upon reception of a write request for one of storage areas within the logical volume that stores data on which encryption is being performed, the disk controller is further configured to wait for the data to be encrypted before executing a processing that fulfills the received write request.

13. A method of switching encryption keys in a storage system coupled to a host computer, the storage system having a disk drive and a disk controller, the disk drive storing data that is requested by the host computer to be written, the disk controller controlling data read and data write to the disk drive, comprising the steps of:
providing, by the disk controller, a storage area of the disk drive to the host computer as at least one logical volumes;
executing, by the disk controller, a processing of switching an encryption key that is used to encrypt data stored in the logical volume from a first encryption key to a second encryption key;
encrypting, by the disk controller, write data which is requested to be written by a received write request with the second encryption key when the write request for one of storage areas within the logical volume that stores data for which switching of encryption keys has not been finished is received while the encryption key switching processing is being executed; and
writing, by the disk controller, the encrypted write data in the logical volume to switch encryption keys for data stored in the storage area where the data is requested to be written by the received write request.

14. The method of switching encryption keys according to claim 13, further comprising the steps of:
judging, by the disk controller, whether switching of encryption keys has been finished for other data included in a parity group to which the data stored in the storage area where the data is requested to be written by the received write request belongs;
reading, by the disk controller, the other data out of the logical volume when it is judged that switching of encryption keys has not been finished for the other data;
decrypting, by the disk controller, the read other data with the first encryption key;
encrypting, by the disk controller, the decrypted other data with the second encryption key; and
writing, by the disk controller, the encrypted other data in the logical volume to switch encryption keys of the other data.

15. The method of switching encryption keys according to claim 14, further comprising the steps of:
creating, by the disk controller, parity data from the write data and the other data which have been encrypted with the second encryption key; and
writing, by the disk controller, the created parity data in the logical volume.

16. The method of switching encryption keys according to claim 13, further comprising the steps of:
judging, by the disk controller, whether switching from the first encryption key to the second encryption key has been finished for other data included in a parity group to which the data stored in the storage area where the data is requested to be written by the received write request belongs;
reading, by the disk controller, the other data encrypted with the second encryption key out of the logical volume when it is judged that the switching of the encryption keys has been finished for the other data;
creating, by the disk controller, parity data from the write data and the other data which have been encrypted with the second encryption key; and
writing, by the disk controller, the created parity data in the logical volume.

17. The method of switching encryption keys according to claim 13, wherein the storage system stores encryption state management information which indicates whether switching of encryption keys has been finished for data stored in a storage area within the logical volume.

18. The method of switching encryption keys according to claim 13, further comprising the step of, waiting, by the disk controller, upon reception of a write request for one of storage areas within the logical volume that stores data on which switching of encryption keys is being performed, for the data to finish switching encryption keys before executing a processing that fulfills the received write request.
